(19) United States
(12) Patent Application Publication
(10) Pub. No.: US 2012/0272698 A1
(43) Pub. Date: Nov. 1, 2012

(54) KEY AND MOTOR VEHICLE EQUIPPED THEREWITH

(75) Inventor: Joerg GSCHWENG, Mainz (DE)

(73) Assignee: GM GLOBAL TECHNOLOGY OPERATIONS LLC, Detroit, MI (US)

(21) Appl. No.: 13/459,639

(22) Filed: Apr. 30, 2012

(30) Foreign Application Priority Data
Apr. 29, 2011 (DE) 10 2011 100 032.5

(51) Int. Cl. E05B 19/04; E05B 19/00

(52) U.S. Cl. 70/396

(57) ABSTRACT

In a key, in particular a motor vehicle key, having a key head manufactured from plastic and a bit, which is anchored on the key head and is movable between an idle position and a usage position protruding from the key head, a first part of the key head, on which the bit engages, is manufactured from a fiber-reinforced plastic and a second part, which forms an outer envelope of the key head, is manufactured from a fiber-free plastic.

### CROSS-REFERENCE TO RELATED APPLICATION

This application claims priority to German Patent Application No. 10 2011 100 032.5, filed Apr. 29, 2011, which is incorporated herein by reference in its entirety.

### TECHNICAL FIELD

The technical field relates to a key, in particular a motor vehicle key, and a motor vehicle equipped with such a key.

### BACKGROUND

In modern motor vehicles, a transponder circuit is often housed in the key head, which allows the remote operation of a central locking system of the motor vehicle, without the key bit having to be inserted into a lock. The space required for the circuit and the buttons required for its operation have the result that such a key head is larger than a normal key head, which is only used as a handle for rotating the key bit. In order to nonetheless keep the key compact, the bit of such a key is typically movable between a usage position protruding from the key head and an idle position which presses against the key head or is even countersunk therein.

The mobility of the bit, on the one hand, and the necessity of transmitting a torque between key head and key bit in the usage position, on the other hand, places high requirements on the carrying capacity of the material of the key head. Plastics must typically contain a reinforcing fiber component to be able to meet these requirements.

A plastic of the key head is reinforced by fibers, is known, e.g., from DE 2007 035 529 A1. The necessity of using fiber-reinforced plastics significantly restricts the possibilities for the external design of the key. Essentially only matte surfaces of the key head are implementable because of the inhomogeneous material. The use of carbon fibers, as proposed in the document, determines the color of the key head, so that essentially only black or dark surfaces are implementable. A glass fiber component which is also proposed causes a gray tint.

In view of the foregoing, at least one object is therefore to provide a key having movable bit and key head manufactured from plastic, which is durable and in which nonetheless the design of the surface of the key head is not subject to any substantial restrictions, and in which in particular the key head can be manufactured in arbitrary colors and/or having a glossy surface. In addition, other objects, desirable features and characteristics will become apparent from the subsequent summary and detailed description, and the appended claims, taken in conjunction with the accompanying drawings and this background.

### SUMMARY

A key is provided, in particular a motor vehicle key, having a key head manufactured from plastic and a bit which is anchored on the key head and is movable between an idle position and a usage position protruding from the key head, a first part of the key head, on which the bit engages, is manufactured from a fiber-reinforced plastic, and a second part, which forms an outer envelope of the key head, is manufactured from a fiber-free plastic. This separation between a first part, which is decisive for the secure hold of the bit, and a second part, which determines the external appearance, allows material and surface quality of the second part to be selected substantially separately from the strength considerations, which affect the suspension of the key bit. Polyamide comes into consideration in particular as a durable, variably colorable plastic, which is capable of implementing different surface qualities.

Efficient manufacturing is possible in that preferably one of the two parts is manufactured by injection molding in a mold already containing the respective other part. The other part is preferably the second part, i.e., the part made of fiber-reinforced plastic which holds the bit is injected into the prefinished outer envelope.

The second part can expediently also be manufactured as an injection-molded part, e.g., to guarantee a wall thickness which does not permit the material of the first part located underneath to show through even in the event of deep scratches, on the other hand, because an undercut is readily implementable on an injection-molded second part, in which the first part engages, to ensure a permanent formfitting cohesion between both parts. The second part is to be homogeneously colored, to prevent the color of the key head from changing due to surface abrasion in the course of use.

If the key is intended for a motor vehicle, the second part can expediently be colored in the color of the vehicle body of the motor vehicle, to make the association of the key with the motor vehicle noticeable at first glance and to ensure that keys can be differentiated even if a user uses multiple motor vehicles of the same producer and associated keys.

If multiple keys of the above-described type are assigned to one motor vehicle, they can expediently have different second parts. Such an individualization of the keys allows, e.g., multiple users of the same vehicle to reliably differentiate their keys. Thus, if a key is missing, it is easier to ascertain which user has misplaced his key, which generally makes it easier to find it again.

### BRIEF DESCRIPTION OF THE DRAWINGS

A description is provided in conjunction with the following drawing figures, where like numerals denote like elements, and:

FIG. 1 shows a top view of a key according to an embodiment; and

FIG. 2 and FIG. 3 show sections through shell parts, which form the head of the key, along plane II-II of FIG. 1; and

FIG. 4 shows a section through the key head along plane IV-IV of FIG. 1.

### DETAILED DESCRIPTION

The following detailed description is merely exemplary in nature and is not intended to limit application and uses. Furthermore, there is no intention to be bound by any theory presented in the preceding background or summary or the following detailed description.

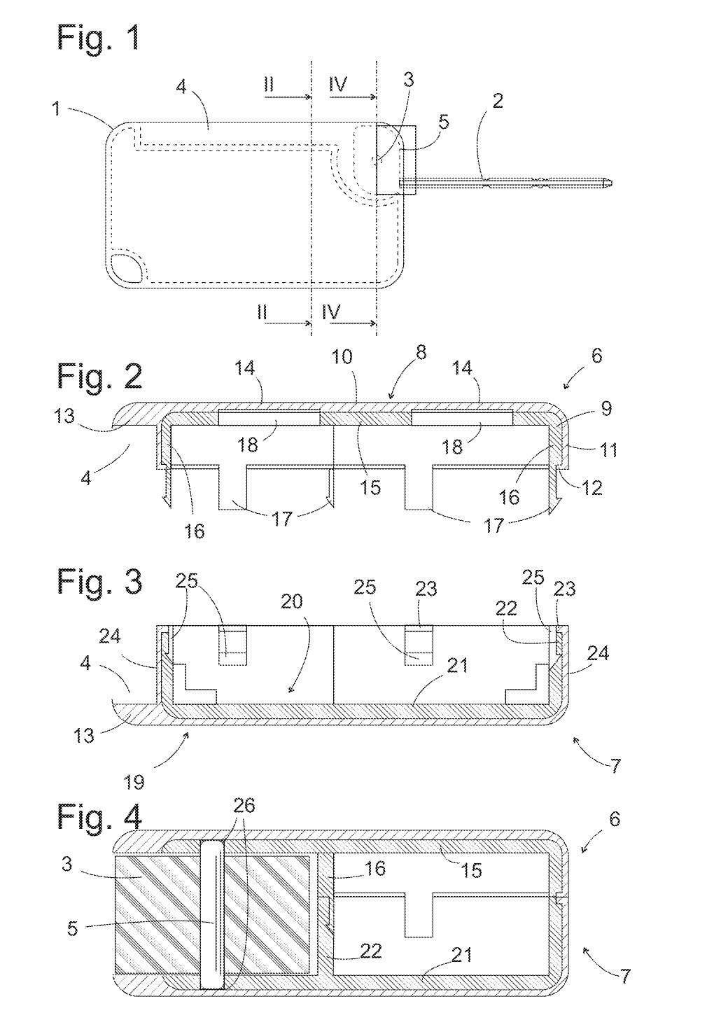

FIG. 1 shows a schematic top view of an ignition key for a motor vehicle having an approximately cuboid head 1 here and a bit 2, which is pivotable by approximately 180° in relation to the head 1 around an axis 3, which is perpendicular to the plane of the drawing, between the usage position shown and an idle position, in which it is countersunk in a lateral recess 4 of the head 1. The axis 3 can be, e.g., a metal cylindrical pin, whose ends are each accommodated so they are rotatable in recesses of an upper and a lower wall of the head 1. It is also conceivable, however, to implement the axis in the form of pins in one piece with the upper and/or lower side of the head 1, which engage from two sides in a hole of a pivotable base 5 of the bit 2 (which is concealed in the view of FIG. 1 under the upper side of the head 1 and is therefore shown by dashed lines).

These upper and lower sides are, in the embodiment shown here, each an integral component of an upper or lower shell 6 or 7, respectively, which can be locked on one another, in order to form the head 1, and which are each shown in FIG. 2 or FIG. 3, respectively, in a section along line II-II from FIG. 1. The upper shell 6 of FIG. 2 comprises an outer shell 8 injection molded from homogeneously colored polyamide and an inner shell 9, which has a glass-fiber-reinforced plastic and is injected into the outer shell 8. The outer shell 8 comprises a flat, thin-walled base plate 10, a peripheral rib 11 around the base plate 10, which bears an inwardly directed web 12 on each of its ends facing away from the base plate 10, and, on a part of the edge of the base plate 10, a web 13, which protrudes in flush extension of the base plate 10 beyond the rib 11 and forms a side wall of the recess 4. The web 13 can be molded as shown completely from the colored polyamide, however, notwithstanding the drawing, it can also have a core made of the glass-fiber-reinforced plastic, which is coherent with the inner shell 9.

The base plate 10 can be made thinner at points to provide elastically deflectable areas 14, on which a user can press in order to operate switches located underneath of a transponder circuit (not shown) installed in the interior of the head 1. The inner shell 9, which is molded from the fiber-reinforced plastic, comprises a base plate 15, which is congruent with the base plate 10 and stiffens it, and a peripheral rib 16 around their edge, essentially fills up an undercut formed by the web 12, the rib 11, and the base plate 10, and thus connects the shells 7, 8 to one another in a formfitting manner. Since the material of the inner shell 9 is tougher because of its fiber component than the fiber-free polyamide of the outer shell 8, catch hooks 17 of the upper shell 6 which protrude beyond the rib 11 are preferably implemented in one piece with the inner shell 9. Windows 18 that are congruent with the deflectable areas 14 are left out in the base plate 15.

The lower shell 7 shown in FIG. 3 has a substantially similar construction to the upper shell 6. An inner shell 20 made of fiber-reinforced plastic is also injected into an outer shell 19 made of colored polyamide here and secured in a formfitting manner therein, in that the tips of a rib 22 which encloses a base plate 21 of the inner shell contacts an inwardly directed web 23 of a rib 24 of the outer shell 19, which is homologous to the rib 11. Notches 25 left out of the rib 24 are provided in order to accommodate the catch hooks 17.

FIG. 4 shows the shells 6 and 7 of the key head 1, which are locked on one another, in a section along plane IV-IV of FIG. 1 extending through the axis 3. In this sectional plane, the base plates 15, 21 extend laterally beyond the ribs 16, 22, and holes 26 which accommodate the axis 3 are left out in the areas protruding beyond the ribs 16, 22.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A key for a motor vehicle, comprising:
a key head manufactured at least in part from plastic;
a bit that is anchored on the key head and movable between an idle position and a usage position protruding from the key head,
wherein a first part of the key head that is configured to engage the bit that is at least partially manufactured from a fiber-reinforced plastic,
wherein second part forms an outer envelope of the key head that is at least partially manufactured from a fiber-free plastic.

2. The key according to claim 1, wherein the fiber-free plastic is a polyamide.

3. The key according to claim 1, wherein the first part is at least partially manufactured by injection molding in a mold containing another part.

4. The key according to claim 1, wherein the second part is at least partially manufactured by injection molding in a mold containing another part.

5. The key according to claim 2, wherein the another part is the first part.

6. The key according to claim 2, wherein the another part is the second part.

7. The key according to claim 1, wherein the second part is an injection-molded part.

8. The key according to claim 1, wherein the second part comprises an undercut that is configured to engage the first part.

9. The key according to claim 1, wherein the second part is colored in a substantially homogeneously manner.
